(19) United States
(12) Patent Application Publication
(10) Pub. No.: US 2026/0347538 A1
(43) Pub. Date: Nov. 5, 2026

(54) BATCH PROCESS FOR PREPARING A POLYETHER POLYOL USING A DOUBLE METAL CYANIDE CATALYST

(71) Applicant: SHELL USA, INC., Houston, TX (US)

(72) Inventors: Paul DAVIS, Bangalore North (IN); Sandip Shripad TALWALKAR, Bangalore North (IN); Prashant Anil TATAKE, Amsterdam (NL); Saikiran MALEPPAGARI, Bangalore North (IN); Rama Tejaswi KARIPEDDI, Bangalore North (IN)

(21) Appl. No.: 19/120,360

(22) PCT Filed: Oct. 25, 2023
(86) PCT No.: PCT/EP2023/079780

§ 371 Date: Apr. 11, 2025

(30) Foreign Application Priority Data
Oct. 28, 2022 (EP) 22204312.7

(51) Int. Cl. C08G 65/26; C08G 18/48

(52) U.S. Cl. CPC C08G 65/2663; C08G 18/4829; C08G 18/4866; C08G 65/2609; C08G 2110/0008

(57) ABSTRACT

The invention relates to a batch process for preparing a polyether polyol P having a hydroxyl number of greater than 115 mg KOH/g. The process includes a) forming a starter mixture comprising starter compound S₁ and a composite metal cyanide complex catalyst, followed by b) continuously adding an alkylene oxide; and; wherein starter compound S₁ has (I) a nominal functionality which equals the nominal functionality of polyether polyol P and a hydroxyl number which is within 10% of the hydroxyl number of polyether polyol P and/or (II) an equivalent weight of from 10 to 500 g/mol; and no alkylene oxide is added in step a) or between steps a) and b), and the continuous addition of alkylene oxide in step b) is not interrupted before the total weight of alkylene oxide needed to prepare polyether polyol P has been added.

### FIELD OF THE INVENTION

The present invention relates to a process for preparing a polyether polyol, to the polyether polyol obtainable by said process, to a process for preparing a polyurethane foam using said polyether polyol, to the polyurethane foam obtainable by said process, and to a shaped article comprising said polyurethane foam.

### BACKGROUND OF THE INVENTION

Polyether polyols are commonly used for the manufacture of polyurethane foams, such as flexible polyurethane foams, which have found extensive use in a multitude of industrial and consumer applications. Polyether polyols are also frequently referred to as polyoxyalkylene polyols. Polyether polyols are typically obtained by reacting a starter compound or initiator having a plurality of active hydrogen atoms, such as glycerol, with one or more alkylene oxides, such as ethylene oxide and propylene oxide. Known suitable catalysts for this reaction comprise composite metal cyanide complex catalysts, which are frequently also referred to as double metal cyanide (DMC) catalysts.

Advantages associated with DMC-catalysed production of polyether polyols is that it is faster and more efficient than the traditional process using potassium hydroxide (KOH) as catalyst. Further, the DMC-catalysed process is more environmentally friendly and has a decreased carbon (CO₂) footprint. However, when the DMC-catalysed process is run as a batch process, the DMC catalyst first needs to be activated. It is known to combine, at the beginning of a batch process, a small amount of alkylene oxide, for example propylene oxide, with a reactive compound, such as some polyether polyol from a previous batch, in the presence of the DMC catalyst. After some time, the DMC catalyst is activated, as shown by a drop in alkylene oxide pressure. Then at some point after activation, more alkylene oxide and the initiator may be added continuously to produce the desired polyether polyol.

EP3184575A1 discloses a batch process for the production of low molecular weight polyoxyalkylene polyols which have hydroxyl numbers of from 200 to 500 mg KOH/g, wherein a first alkylene oxide block activates a double metal cyanide (DMC) catalyst in a mixture of DMC catalyst and initial starter, followed by addition of a second alkylene oxide block and continuous introduction of one or more starters. Said process of EP3184575A1 comprises a separate DMC catalyst activation step, as also illustrated in its Examples. In Example 1 of said EP3184575A1, a polyether polyol (Polyol A) and a DMC catalyst (Catalyst A) were charged to a reactor. Then propylene oxide and ethylene oxide were charged to activate the catalyst. This caused the pressure to increase, after which it steadily decreased indicating the catalyst was activated. Then the propylene oxide and ethylene oxide feeds were restarted, and after some time glycerol and propylene glycol feeds were started.

However, a separate DMC catalyst activation step, as described above, takes time and hence extends total production time in batchwise polyether polyol production processes. It is an object of the present invention to provide a batchwise polyether polyol production process which may have a reduced total batch time. Further, it is an object of the present invention to reduce total DMC catalyst amount needed in such batch process, while still achieving efficient production. Still further, it is an object of the present invention to increase the tolerance to impurities, such as water, which may be present in the initiator, such as glycerol.

### SUMMARY OF THE INVENTION

Surprisingly it was found that one or more of the above-mentioned objects may be achieved by a batch polyether polyol production process, wherein a polyether polyol having a hydroxyl number of greater than 115 mg KOH/g is prepared by reacting one or more starter compounds with one or more alkylene oxides in the presence of a composite metal cyanide complex catalyst (a double metal cyanide (DMC) catalyst) and wherein alkylene oxide is continuously added, characterized in that above-mentioned separate DMC catalyst activation step is omitted and in that (i) alkylene oxide is only added in the step of continuously adding alkylene oxide and (ii) the continuous addition of alkylene oxide in the latter step is only stopped once the total weight of alkylene oxide needed to prepare polyether polyol P has been added.

Accordingly, the present invention relates to a batch process for preparing a polyether polyol P having a hydroxyl number of greater than 115 mg KOH/g by reacting starter compound S₁ and optionally starter compound S₂, which starter compounds have a plurality of active hydrogen atoms, with one or more alkylene oxides in the presence of a composite metal cyanide complex catalyst, comprising
a) forming a starter mixture comprising starter compound S₁ and the catalyst, followed by
b) continuously adding an alkylene oxide; and
c) optionally: continuously adding starter compound S₂;
wherein
starter compound S₁ has (I) a nominal functionality which equals the nominal functionality of polyether polyol P and a hydroxyl number which is within 10% of the hydroxyl number of polyether polyol P and/or (II) an equivalent weight of from 10 to 500 g/mol;
optional starter compound S₂ has an equivalent weight of from 10 to 70 g/mol; and
no alkylene oxide is added in step a) or between steps a) and b), and the continuous addition of alkylene oxide in step b) is not interrupted before the total weight of alkylene oxide needed to prepare polyether polyol P has been added.

Further, the present invention relates to a polyether polyol obtainable by the above-mentioned process.

The present invention also relates to a process for preparing a polyurethane foam comprising reacting a polyether polyol and a polyisocyanate in the presence of a blowing agent, wherein the polyether polyol is a polyether polyol obtained or obtainable by the above-mentioned process.

Further, the present invention relates to a polyurethane foam obtainable by the above-mentioned process for preparing a polyurethane foam, and to a shaped article comprising a polyurethane foam obtained or obtainable by said process.

### DETAILED DESCRIPTION OF THE INVENTION

While the processes and compositions of the present invention may be described in terms of “comprising”, “containing” or “including” one or more various described steps and components, respectively, they can also “consist essentially of” or “consist of” said one or more various described steps and components, respectively.

In the context of the present invention, in a case where a composition comprises two or more components, these components are to be selected in an overall amount not to exceed 100 wt. %.

Where upper and lower limits are quoted for a property then a range of values defined by a combination of any of the upper limits with any of the lower limits is also implied.

The term “molecular weight” (or “MW”) is used herein to refer to number average molecular weight, unless otherwise specified or context requires otherwise. The number average molecular weight of a polyol can be measured by gel permeation chromatography (GPC) or vapor pressure osmometry (VPO).

The term “hydroxyl (OH) value” or “hydroxyl (OH) number” is used herein to refer to the milligrams of potassium hydroxide equivalent to the hydroxyl content in one gram of polyol determined by wet method titration. Hence, said OH value or number is expressed in mg KOH/g. The hydroxyl number may be determined according to ASTM D4274.

The term “equivalent weight” (or “EW”) is used herein to refer to the weight of polyol per reactive site. The equivalent weight is 56,100 divided by the hydroxyl value of the polyol.

The term “functionality” or “hydroxyl (OH) functionality” of a polyol refers to the number of hydroxyl groups per molecule of polyol. The nominal functionality of a polyol is the same as that of its starter compound (initiator). Unless indicated otherwise, functionality refers to the actual average functionality which may be lower than the nominal functionality and is determined by the number average molecular weight of the polyol divided by the equivalent weight of the polyol.

The term “primary hydroxyl content” (or “PHC”) is used herein to refer to the relative proportion (in %) of primary hydroxyl groups in a polyether polyol based on total number of hydroxyl groups including primary and secondary hydroxyl groups. The primary hydroxyl content may be determined according to ASTM D4273.

The terms “ethylene oxide content” and “propylene oxide content”, respectively, in relation to a polyether polyol refer to those parts of the polyol which are derived from ethylene oxide and propylene oxide, respectively. Said contents may also be referred to as oxyethylene content and oxypropylene content, respectively. Further, said contents are based herein on total alkylene oxide weight. The ethylene oxide content may be determined according to ASTM D4875.

The process of the present invention is a batch process. In a batch process, the desired product which in the present invention is polyether polyol P, is not continuously prepared in a reactor but is prepared during a certain period of time in the reactor, after which at least part of the product is recovered, after which a new batch can be started.

In the present invention, polyether polyol P has a hydroxyl number of greater than 115 mg KOH/g, suitably greater than 120 mg KOH/g. The hydroxyl number of polyether polyol P may be at least 120 mg KOH/g or at least 130 mg KOH/g or at least 140 mg KOH/g or at least 160 mg KOH/g or at least 180 mg KOH/g or at least 200 mg KOH/g or at least 220 mg KOH/g. Further, the hydroxyl number of polyether polyol P may be at most 500 mg KOH/g or at most 450 mg KOH/g or at most 400 mg KOH/g or at most 350 mg KOH/g or at most 300 mg KOH/g or at most 280 mg KOH/g.

Further, in the present invention, polyether polyol P contains ether linkages (or ether units). Further, said polyether polyol may additionally contain ester linkages (or ester units) and/or carbonate linkages (or carbonate units). It is preferred that said polyether polyol does not contain ester linkages (or ester units). Further, it is preferred that said polyether polyol does not contain carbonate linkages (or carbonate units). Still further, said polyether polyol may consist of ether linkages.

In step a) of the present process, a starter mixture comprising starter compound S₁ and a composite metal cyanide complex catalyst is formed. Step a) is performed before step b) and optional step c) is or are performed. Preferably, in step a), the starter mixture is formed in a reactor. Alternatively, said starter mixture may be formed outside the reactor after which the reactor is charged with the thus obtained starter mixture.

Thus, in the process of the present invention, a composite metal cyanide complex catalyst is used. Composite metal cyanide complex catalysts are frequently also referred to as double metal cyanide (DMC) catalysts. A composite metal cyanide complex catalyst is typically represented by the following formula (1):

M¹ₐ[M²_{b}(CN)_{c}]_{d}·e(M¹_{f}X_{q})·h(H₂O)·i(R) (1)
wherein each of M¹ and M² is a metal, X is a halogen atom, R is an organic ligand, and each of a, b, c, d, e, f, g, h and i is a number which is variable depending upon the atomic balances of the metals, the number of organic ligands to be coordinated, etc.

In the above formula (1), M¹ is preferably a metal selected from Zn(II) or Fe(II). In the above formula, M² is preferably a metal selected from Co(III) or Fe(III). However, other metals and oxidation states may also be used, as is known in the art.

In the above formula (1), R is an organic ligand and is preferably at least one compound selected from the group consisting of an alcohol, an ether, a ketone, an ester, an amine and an amide. As such an organic ligand, a water-soluble one may be used. Specifically, one or more compounds selected from tert-butyl alcohol, n-butyl alcohol, iso-butyl alcohol, tert-pentyl alcohol, isopentyl alcohol, N, N-dimethyl acetamide, glyme (ethylene glycol dimethyl ether), diglyme (diethylene glycol dimethyl ether), triglyme (triethylene glycol dimethyl ether), ethylene glycol mono-tert-butylether, iso-propyl alcohol and dioxane, may be used as organic ligand(s). The dioxane may be 1,4-dioxane or 1,3-dioxane and is preferably 1,4-dioxane. Most preferably, the organic ligand or one of the organic ligands in the composite metal cyanide complex catalyst is tert-butyl alcohol. Further, as an alcohol organic ligand, a polyol, preferably a polyether polyol may be used. More preferably, a poly(propylene glycol) having a number average molecular weight in the range of from 500 to 2,500 Dalton, preferably 800 to 2,200 Dalton, may be used as the organic ligand or one of the organic ligands. Most preferably, such poly(propylene glycol) is used in combination with tert-butyl alcohol as organic ligands. The composite metal cyanide complex catalyst can be produced by known production methods.

In the present invention, starter compound S₁ meets one or both of the following two requirements (I) and (II):
(I) starter compound S₁ has a nominal functionality which equals the nominal functionality of polyether polyol P and a hydroxyl number which is within 10% of the hydroxyl number of polyether polyol P and/or
(II) starter compound S₁ has an equivalent weight of from 10 to 500 g/mol.

Thus, in the present invention, compound S₁ may meet requirement (I) only or may meet requirement (II) only or may meet both requirements (I) and (II).

Under requirement (I), starter compound S₁ has a hydroxyl number which is within 10% of the hydroxyl number of polyether polyol P. This means that under requirement (I), the hydroxyl number of starter compound S₁ does not differ by more than 10% from the hydroxyl number of polyether polyol P. Preferably, under requirement (I), starter compound S₁ has a hydroxyl number which is within 8%, more preferably within 6%, more preferably within 4%, more preferably within 2%, most preferably within 1% of the hydroxyl number of polyether polyol P. Further, starter compound S₁ may have a hydroxyl number which equals the hydroxyl number of polyether polyol P.

Requirement (I) is met in a case wherein a portion of polyether polyol P as prepared in a previous batch in accordance with the process of the present invention, is used as starter compound S₁ in a next batch in accordance with the process of the present invention. Thus, starter compound S₁ may comprise the same product as the final targeted product (polyether polyol P). Up to 50 wt. % or up to 40 wt. % or up to 30 wt. % or up to 20 wt. % or up to 10 wt. % or up to 5 wt. % of the total weight of polyether polyol P as prepared in said previous batch may be used as starter compound S₁ in said next batch. At the end of a batch process a portion of said polyether polyol P thus prepared may be left in a reactor (generally also referred to as “heel”) and be used as starter compound S₁ in the next batch. It is also possible that said polyether polyol P thus prepared is first stored in a separate storage vessel, and that later a portion thereof is brought back into the reactor and used as starter compound S₁ in the next batch. Prior to step a) of the present process, above-mentioned “heel” may be subjected to a pre-treatment, wherein such pre-treatment may for example comprise stripping using a stripping gas in order to remove light compounds (such as moisture) and/or refining in order to remove or neutralize any non-DMC catalyst (such as KOH) used in a previous batch.

Further, in the present invention, starter compound S₁ may comprise an intermediate polyether polyol which does not correspond with polyether polyol P to be prepared in accordance with the process of the present invention. In particular, such intermediate polyether polyol may be a polyether polyol prepared using a catalyst other than a composite metal cyanide complex catalyst, for example a potassium hydroxide (KOH) catalyst. When starting up the first batch of a batch process in which case there is no product from a previous batch a portion of which could be used as starter compound S₁, first an intermediate polyether polyol product may be prepared using such other catalyst, before using a composite metal cyanide complex catalyst for preparing the final polyether polyol product (polyether polyol P). In cases wherein starter compound S₁ comprises such intermediate product, step c) wherein starter compound S₂ is continuously added, is preferably not carried out. However, in cases wherein starter compound S₁ does not comprise such intermediate product, step c) is preferably carried out in order to prepare polyether polyol P.

Under requirement (II), starter compound S₁ has an equivalent weight of from 10 to 500 g/mol. Under said requirement (II), starter compound S₁ may have an equivalent weight of at least 40 g/mol or at least 45 g/mol or at least 50 g/mol or at least 55 g/mol or at least 65 g/mol or at least 80 g/mol or at least 100 g/mol or at least 120 g/mol or at least 140 g/mol or at least 160 g/mol or at least 180 g/mol or at least 200 g/mol. Further, under said requirement (II), starter compound S₁ may have an equivalent weight of at most 500 g/mol or at most 450 g/mol or at most 400 g/mol or at most 350 g/mol or at most 300 g/mol or at most 280 g/mol or at most 250 g/mol.

A case wherein only requirement (II) is met, and requirement (I) is not met, is a case wherein in a previous batch another polyether polyol (another polyol grade) is prepared, which has a nominal functionality which is different from that of the desired polyether polyol P to be made in the next batch and/or which has a hydroxyl number which differs by more than 10% from the hydroxyl number of said polyether polyol P. When such grade change is carried out, a portion of the other polyether polyol as prepared in a previous batch, may be used as starter compound S₁ in a next batch wherein polyether polyol P is prepared in accordance with the process of the present invention. Thus, starter compound S₁ may comprise a product which is different from the final targeted product (polyether polyol P). Up to 50 wt. % or up to 40 wt. % or up to 30 wt. % or up to 20 wt. % or up to 10 wt. % or up to 5 wt. % of the total weight of said other polyether polyol as prepared in said previous batch may be used as starter compound S₁ in said next batch. At the end of a batch process a portion of said other polyether polyol thus prepared may be left in a reactor (generally also referred to as “heel”) and be used as starter compound S₁ in the next batch wherein polyether polyol P is prepared. It is also possible that said other polyether polyol thus prepared is first stored in a separate storage vessel, and that later a portion thereof is brought back into the reactor and used as starter compound S₁ in the next batch wherein polyether polyol P is prepared. Prior to step a) of the present process, above-mentioned “heel” may be subjected to a pre-treatment, wherein such pre-treatment may for example comprise stripping using a stripping gas in order to remove light compounds (such as moisture) and/or refining in order to remove or neutralize any non-DMC catalyst (such as KOH) used in a previous batch.

The amount of starter compound S₁ used in step a) of the present process, on the basis of the total weight of final product (polyether polyol P) in the reactor, may vary within wide ranges. Said proportion may be of from 1 to 80 wt., or 3 to 70 wt. %, or 5 to 60 wt. %, or 7 to 50 wt. %, or 8 to 40 wt. %. Said proportion is related to the so-called “build ratio” which in the present specification is defined as the ratio of the total weight of final product in the reactor to the weight of starter compound S₁.

Starter compound S₁ may consist of one starter compound which meets one or both of requirements (I) and (II). Alternatively, starter compound S₁ may consist of a mixture of two or more starter compounds, suitably two starter compounds, each of which meets one or both of requirements (I) and (II). In the latter case, for example, one of the starter compounds may meet requirements (I) and (II) whereas another starter compound may only meet requirement (II). Further, additionally, in step a) of the present process, one or more starter compounds other than starter compound S₁, may be used in forming the starter mixture. Preferably, in the present invention, starter compounds not meeting any one of requirements (I) and (II) are not used in step a).

In step a) of the present process, in addition to a starter compound which meets requirement (I), such as above-described “heel” comprising polyether polyol P as prepared in a previous batch in accordance with the process of the present invention, a starter compound having a hydroxyl number which exceeds that of polyether polyol P by more than 10% and having a relatively low equivalent weight, suitably an equivalent weight in the range of from 10 to 250 g/mol or 20 to 70 g/mol or 30 to 50 g/mol, may be used in forming the starter mixture. Such additional low equivalent weight starter compound may have a functionality of from 2 to 8, or preferably 2 to 3. Some suitable examples of such additional low equivalent weight starter compound include diols and triols such as, for example, ethylene glycol, propylene glycol, butylene glycol, glycerol, water, trimethylolpropane, sorbitol, sucrose and other low equivalent weight polyether polyols which have an equivalent weight within one of the above-mentioned ranges. Such additional low equivalent weight starter compound is preferably used in step a) in a relatively small amount, which may be of from 0.1 to 2.0 wt. % or 0.25 to 1.75 wt. % or 0.5 to 1.5 wt. % based on the weight of the other starter compound which meets requirement (I). Advantageously, by adding such additional low equivalent weight starter compound, the polydispersity and viscosity of the final polyether polyol P may be reduced.

In step a) of the present process, a starter mixture comprising starter compound S₁ and a composite metal cyanide complex catalyst is formed. In step a), starter compound S₁ may be combined with composite metal cyanide complex catalyst as described above, wherein said catalyst to be combined with starter compound S₁ preferably comprises fresh composite metal cyanide complex catalyst. Within the present specification, a “fresh” catalyst means a not-activated catalyst which has not been used as a catalyst in a chemical process before, in specific a not-activated catalyst which has not been exposed to alkylene oxide before. The fresh catalyst is, however, suitable to be used as a catalyst in a chemical process, which means that it is a final catalyst obtained as the product in a catalyst preparation process, and not any intermediate catalyst or catalyst precursor. Within the present specification, a “used” catalyst means a catalyst which has been used as a catalyst in a chemical process before, in specific a catalyst which has been exposed to alkylene oxide before.

Above-mentioned fresh composite metal cyanide complex catalyst which is preferably used in step a) should be distinguished from any composite metal cyanide complex catalyst that may be present in starter compound S₁ before forming, in said step a), a starter mixture comprising starter compound S₁ and a composite metal cyanide complex catalyst which preferably comprises fresh composite metal cyanide complex catalyst. Composite metal cyanide complex catalyst present in starter compound S₁ before step a), may originate from a previous batch wherein a composite metal cyanide complex catalyst is also used in preparing a polyether polyol, a portion of which polyether polyol may subsequently be used as starter compound S₁ in a next batch wherein polyether polyol P is prepared in accordance with the process of the present invention. Hence, starter compound S₁ may comprise a used composite metal cyanide complex catalyst. Further, preferably, starter compound S₁ does not comprise a fresh composite metal cyanide complex catalyst.

Hence, in the present invention, polyether polyol P is prepared in the presence of a composite metal cyanide complex catalyst which comprises (i) composite metal cyanide complex catalyst used in step a) to form a starter mixture comprising starter compound S₁ and said catalyst, which catalyst (i) preferably comprises fresh catalyst, and (ii) optionally composite metal cyanide complex catalyst present in starter compound S₁ before step a), which catalyst (ii) may comprise used catalyst.

In the present invention, in a case wherein starter compound S₂ is added in step c), step b) may start before step c) or steps b) and c) may start simultaneously or step c) may start before step b). In such case, it is preferred that step b) starts before step c). In the present invention, polyether polyol P is prepared in a reactor. However, as mentioned above, step a) may be performed within the reactor or, alternatively, may be performed outside the reactor after which the reactor is charged with the thus obtained starter mixture. Steps b) and c) are performed within the reactor, meaning that in step b) alkylene oxide is continuously added to the reactor, and in optional step c) starter compound S₂ is continuously added to the reactor.

Further, in the present invention, no alkylene oxide is added in step a) or between steps a) and b). This means that in the present invention, alkylene oxide is only added in step b). Further, in the present invention, the continuous addition of alkylene oxide in step b) is not interrupted before the total weight of alkylene oxide needed to prepare polyether polyol P has been added. This means that in the present invention, the continuous addition of alkylene oxide in step b) is not discontinued temporarily but is only stopped once the total weight of alkylene oxide needed to prepare polyether polyol P has been added.

Advantageously, in the present invention, the composite metal cyanide complex catalyst, that is used in step a) to form a starter mixture comprising starter compound S₁ and said catalyst and that preferably comprises fresh composite metal cyanide complex catalyst (DMC catalyst), as mentioned above, may be activated in step b) and is preferably not activated before step b). Especially, in the present invention, said catalyst may advantageously be activated in an early stage of step b), for example when of from 0.5 to 10% or 1 to 5 wt. % or 1.5 to 3 wt. % of the total amount of continuously added alkylene oxide has been added. Hence, surprisingly, it has appeared in the present invention that there is advantageously no need for a process involving a separate DMC catalyst activation step, that is to say a process wherein first a relatively small amount of alkylene oxide is added to a starter compound and the composite metal cyanide complex catalyst, followed by a waiting period for activation of said catalyst, after which activation further alkylene oxide may be added.

As mentioned above, in the present invention, alkylene oxide is only added in step b), and the continuous addition of alkylene oxide in step b) is only stopped once the total weight of alkylene oxide needed to prepare polyether polyol P has been added. Said alkylene oxide added in step b) may comprise one or more of propylene oxide, ethylene oxide and butylene oxide, preferably propylene oxide and ethylene oxide, most preferably only propylene oxide.

Polyether polyol P prepared in the process of the present invention, comprises polyether chains preferably containing propylene oxide content, optionally butylene oxide content and optionally ethylene oxide content.

Preferably, the propylene oxide content of polyether polyol P is at least 70 wt. %, more preferably at least 80 wt. %, more preferably at least 90 wt. %, more preferably at least 95 wt. %, most preferably at least 99 wt. %. Further, preferably, the propylene oxide content of polyether polyol P is at most 100 wt. %.

The ethylene oxide content of polyether polyol P may be 0 wt. % or at least 3 wt. % or at least 5 wt. % or at least 10 wt. % or at least 12 wt. % or at least 15 wt. %. Further, the ethylene oxide content of the polyether polyol P may be below 30 wt. % or at most 25 wt. % or at most 20 wt. % or at most 15 wt. % or at most 12 wt. g.

The polyether chains of the polyether polyol P may comprise no ethylene oxide content but may comprise only propylene oxide and/or butylene oxide content, suitably only propylene oxide content.

Further, polyether polyol P may comprise primary hydroxyl groups. The primary hydroxyl content of the polyether polyol P may be 0% or at least 1% or at least 3% or at least 5%. Further, the primary hydroxyl content of polyether polyol P may be at most 15% or at most 10% or at most 5%.

Further, polyether polyol P may have a functionality of from 2 to 6, preferably of from 2 to 4, more preferably of from 2.5 to 3.5, most preferably of from 2.7 to 3.3.

Preferably, in the beginning of step b), the addition rate of alkylene oxide is increased till a target addition rate is reached which is then preferably maintained till the end of step b).

In the present invention, optional starter compound S₂ has an equivalent weight of from 10 to 70 g/mol. Preferably, starter compound S₂ has an equivalent weight of from 10 to 60 g/mol, more preferably 20 to 50 g/mol, more preferably 25 to 40 g/mol, most preferably 30 to 35 g/mol.

Further, preferably, starter compound S₂ is a polyfunctional alcohol, generally containing from 2 to 6 hydroxyl groups. Examples of such alcohols comprise glycols, glycerol, pentaerythritol, trimethylolpropane, triethanolamine, sorbitol and mannitol. Advantageously, monopropylene glycol (MPG), glycerol or a combination of both may be used as starter compound S₂. Preferably, glycerol is used as starter compound S₂.

As mentioned above, it is preferred that step b) starts before optional step c). Further, it is preferred that optional step c) starts before 4 wt. % or before 3 wt. % or before 2 wt. % or before 1 wt. % or before 0.5 wt. % of the total weight of alkylene oxide needed to prepare polyether polyol P has been added in step b).

Preferably, in the beginning of step c), the addition rate of starter compound S₂ is increased till a target addition rate is reached which is then preferably maintained till the end of step c).

Further, in the present invention, it is preferred that once above-mentioned target addition rates for the alkylene oxide and starter compound S₂ have been reached, the weight ratio of the addition rate of the alkylene oxide to the addition rate of starter compound S₂ is of from 2:1 to 10:1 or of from 3:1 to 8:1. In specific, it is preferred that the latter weight ratio is smaller than the weight ratio before said target addition rates have been reached, in which earlier stage the weight ratio of the addition rate of the alkylene oxide to the addition rate of starter compound S₂ may be of from 8:1 to 30:1 or of from 10:1 to 20:1.

In the present invention, it is preferred that optional step c) is stopped before step b) is stopped. In particular, it is preferred that optional step c) is stopped once of from 30 to 99%, more preferably 50 to 99%, more preferably 60 to 97%, more preferably 70 to 95%, more preferably 80 to 93%, most preferably 85 to 93%, of the total weight of alkylene oxide needed to prepare polyether polyol P has been added in step b).

Further, in the present invention, it is preferred that the total amount of starter compound S₂ added in step c) is of from 5 to 25 wt. %, more preferably 6 to 22 wt. %, most preferably 10 to 18 wt. %, based on the sum of the total amount of starter compound S₂ added in step c) and the total amount of alkylene oxide added in step b).

Further, the present invention relates to a polyether polyol obtainable by the above-mentioned process.

The present invention also relates to a process for preparing a polyurethane foam comprising reacting a polyether polyol and a polyisocyanate in the presence of a blowing agent, wherein the polyether polyol is a polyether polyol obtained or obtainable by the above-mentioned batch process.

Further, the present invention relates to a process for preparing a polyurethane foam comprising preparing a polyether polyol P having a hydroxyl number of greater than 115 mg KOH/g in accordance with the above-mentioned batch process, followed by reacting the polyether polyol and a polyisocyanate in the presence of a blowing agent.

In the above-mentioned process for preparing a polyurethane foam, the polyether polyol is reacted with a polyisocyanate in the presence of a blowing agent.

The polyisocyanate may comprise an aromatic polyisocyanate or an aliphatic polyisocyanate, preferably an aromatic polyisocyanate.

The aromatic polyisocyanate may for example comprise tolylene diisocyanate (TDI) or polymeric TDI, xylylene diisocyanate, tetramethylxylylene diisocyanate, methylene diphenyl diisocyanate (MDI) or polymeric MDI (i.e. polymethylene polyphenyl isocyanate), or a modified product thereof. Preferably, the aromatic polyisocyanate comprises tolylene diisocyanate (TDI), i.e. non-polymeric TDI. The TDI may be a mixture of 80 wt. % of 2,4-TDI and 20 wt. % of 2,6-TDI, which mixture is sold as “TDI-80”.

Further, the aliphatic polyisocyanate may for example comprise hexamethylene diisocyanate, dicyclohexylmethane diisocyanate, lysine diisocyanate or isophorone diisocyanate, or a modified product thereof.

Further, the polyisocyanate may comprise any mixture of two or more of the polyisocyanates mentioned above. For example, the polyisocyanate may comprise a mixture of TDI and MDI, in particular a mixture wherein the weight ratio of TDI:MDI varies from 10:90 to 90:10.

The blowing agent may comprise a chemical blowing agent and/or a physical (non-chemical) blowing agent. Within the present specification, by “chemical blowing agent” reference is made to a blowing agent that may only provide a blowing effect after it has chemically reacted with another compound. In case the blowing agent comprises a chemical blowing agent, said chemical blowing agent preferably comprises water. Water reacts with isocyanate groups of the polyisocyanate, thereby releasing carbon dioxide which causes the blowing to occur.

However, other suitable blowing agents, such as for example, acetone, gaseous or liquid carbon dioxide, halogenated hydrocarbons, aliphatic alkanes and alicyclic alkanes may be employed additionally or alternatively.

Due to the ozone depleting effect of fully chlorinated, fluorinated alkanes (CFC's) the use of this type of blowing agent is generally not preferred, although it is possible to use them. Halogenated alkanes, wherein at least one hydrogen atom has not been substituted by a halogen atom (including the so-called HCFC's) have no or less ozone depleting effect and therefore are the preferred halogenated hydrocarbons to be used in physically blown foams. One suitable HCFC type blowing agent is 1-chloro-1,1-difluoroethane. Another suitable halogenated alkane of this type for use as a blowing agent, is methylene chloride (dichloromethane).

The above blowing agents may be used singly or in mixtures of two or more.

The amount of the blowing agent(s) is determined by the desired density of the polyurethane foam to be prepared. For example, a relatively low density can be obtained by using a relatively high amount of the blowing agent(s), and vice versa. A skilled person can readily determine the amount of blowing agent (physical and/or chemical blowing agent) needed to obtain a desired foam density.

Water may be used as a blowing agent in an amount which is at least 0.1 part per hundred parts by weight of polyol (pphp) or at least 0.5 pphp or at least 1 pphp. Further, water may be used as a blowing agent in an amount which is at most 10 parts per hundred parts by weight of polyol (pphp) or at most 5 pphp or at most 3 pphp or at most 2 pphp.

In case of halogenated hydrocarbons, aliphatic alkanes and alicyclic alkanes, the amount of the blowing agent may be of from 1 to 50 parts per hundred parts by weight of polyol (pphp), suitably of from 1 to 30 pphp, more suitably of from 1 to 20 pphp.

Further, preferably, the polyurethane foam which may be prepared is a flexible polyurethane foam. Further, said flexible polyurethane foam is suitably a slabstock foam. Within the present specification, by “slabstock foam” reference is made to a foam that is made by applying a free rise (unconstrained rise) of the foam.

The isocyanate index (or NCO index) may vary within wide ranges and may be of from 60 to 120. In particular, the isocyanate index may be at most 120, more suitably at most 110, more suitably at most 100, most suitably at most 90. Further, the isocyanate index is preferably higher than 60 and may be at least 70 or at least 80 or at least 90. Within the present specification, “isocyanate index” is calculated as 100 times the mole ratio of —NCO groups (isocyanate groups) to NCO-reactive groups in the reaction mixture. In other words, the isocyanate index is defined as: [(actual amount of isocyanate)/(theoretical amount of isocyanate)]*100, wherein the “theoretical amount of isocyanate” equals 1 equivalent isocyanate (NCO) group per 1 equivalent isocyanate-reactive group.

Such “isocyanate-reactive groups” as referred to above include for example OH groups from the polyether polyol and from any water that may be used as a blowing agent. Isocyanate groups also react with water.

Additionally, other components may also be present during the above-mentioned polyurethane foam preparation process, such as one or more polyurethane catalysts, surfactants and/or cross-linking agents.

Polyurethane catalysts are known in the art and include many different compounds. Suitable catalysts include tin-, lead- or titanium-based catalysts, preferably tin-based catalysts, such as tin salts and dialkyl tin salts of carboxylic acids. Specific examples are stannous octoate, stannous oleate, dibutyltin dilaureate, dibutyltin acetate and dibutyltin diacetate. Other suitable catalysts are tertiary amines, such as, for instance, bis(2,2′-dimethylamino)ethyl ether, trimethylamine, triethylamine, triethylenediamine and dimethylethanolamine (DMEA). Examples of commercially available tertiary amine catalysts are those sold under the tradenames Niax, Tegoamin and Dabco (all trademarks). The catalyst is typically used in an amount of from 0.01 to 2.0 parts by weight per hundred parts by weight of polyether polyol (php). Preferred amounts of catalyst are from 0.05 to 1.0 php.

The use of foam stabilisers (surfactants) is well known. Organosilicone surfactants are most conventionally applied as foam stabilisers in polyurethane production. A large variety of such organosilicone surfactants is commercially available. Usually, such foam stabiliser is used in an amount of from 0.01 to 5.0 parts by weight per hundred parts by weight of polyol (pphp). Preferred amounts of stabiliser are from 0.25 to 2.0 pphp, more preferably of from 0.75 to 1.5 pphp.

The use of cross-linking agents in the production of polyurethane foams is also well known. Polyfunctional glycol amines are known to be useful for this purpose. The polyfunctional glycol amine which is most frequently used and is also useful in the preparation of polyurethane foams, especially flexible polyurethane foams, is diethanolamine, often abbreviated as DEOA. A cross-linking agent may be applied in amounts up to 2 parts by weight per hundred parts by weight of polyol (pphp), but amounts in the range of from 0.01 to 0.5 pphp are most suitably applied.

In addition, other well-known auxiliaries, such as colorants, flame retardants and fillers, may also be used during the above-mentioned polyurethane foam preparation process.

Said polyurethane foam preparation process may involve combining the polyisocyanate, the polyether polyol, the blowing agent, a catalyst and optionally surfactant, crosslinker, flame retardant, colorant and/or filler, in any suitable manner to obtain the polyurethane foam. For example, said process may comprise mixing the polyether polyol, the blowing agent, a catalyst and any other optional component(s) except the polyisocyanate, and then adding the polyisocyanate.

Further, the above-mentioned polyurethane foam preparation process may comprise forming the foam into a shaped article before it fully sets. Suitably, forming the foam may comprise pouring the liquid mixture containing all components into a mould before gelling is complete. Further, the present invention relates to a polyurethane foam obtainable by the above-mentioned process for preparing a polyurethane foam, and to a shaped article comprising a polyurethane foam obtained or obtainable by said process.

The invention is further illustrated by the following Examples.

### EXAMPLES

Polyol A=A polyether polyol made by ring-opening polymerization of propylene oxide in the presence of glycerol and a double metal cyanide (DMC) catalyst: MW (molecular weight)=673 g/mol; OH number=250 mg KOH/g; functionality=3.0; EW (equivalent weight)=224 g/mol; DMC catalyst amount=120 parts per million by weight (ppmw).

In Table 1 below, the water amount in the glycerol and the following properties for the final polyether polyol are included for the Reference Example and Examples 1-3: amount of DMC catalyst (in the final polyol), OH value and viscosity.

### Reference Example

600 grams of Polyol A and 0.288 gram of fresh DMC catalyst were charged to a reactor and mixed. The mixture was heated to 138 °C and vacuum was applied to a level of 200 mbara for 60 minutes.

Then 29 grams of propylene oxide (PO) were charged to activate the catalyst, which small amount of PO was continuously fed within 8 minutes. The pressure in the reactor increased to 0.59 bara and then steadily decreased, indicating the catalyst was activated. At 15 minutes after the feed of said small amount of PO was started, the continuous feed of PO was resumed. At 7 minutes after the continuous PO feed was resumed, a continuous feed of glycerol, which contained 1, 600 ppmw of water, was started.

The continuous glycerol feed was stopped at 182 minutes after the continuous PO feed was resumed and once 87% of the total amount of continuously fed PO was fed, which total PO amount was 2,053 grams (excluding the initial PO amount of 29 grams). The total amount of continuously fed glycerol was 331 grams. After stopping the continuous glycerol feed, 261 grams of PO were continuously fed within 32 minutes. After stopping the continuous PO feed, which was at 229 minutes after the feed of the initial PO amount of 29 grams was started, the PO was allowed to react down for 30 minutes followed by stripping for 30 minutes.

### Example 1

600 grams of Polyol A and 0.288 gram of fresh DMC catalyst were charged to a reactor and mixed. The mixture was heated to 138 °C and vacuum was applied to a level of 200 mbara for 60 minutes.

Then a continuous feed of PO was started. All PO fed in this experiment was fed continuously and was fed without any interruption. At 2 minutes after the continuous PO feed was started, a continuous feed of glycerol, which contained 1, 600 ppmw of water, was started. At said 2 minutes, 0.3% of the total amount of continuously added PO had been added. The initial glycerol feed rate was 21 g/h (during first 8 minutes) which was then ramped to a final glycerol feed rate of 110 g/h (during last 176 minutes). The pressure in the reactor increased to 0.68 bara, and once 45 g of PO had been continuously added within 5 minutes (which is 2% of the total amount of continuously added PO) said pressure decreased, indicating the catalyst was activated.

The continuous glycerol feed was stopped at 194 minutes after the continuous PO feed was started and once 91% of the total amount of continuously fed PO was fed, which total PO amount was 2,090 grams. The total amount of continuously fed glycerol was 328 grams. The total amount of continuously fed glycerol, based on the total amount of continuously fed PO and glycerol, was 14 wt. %. After stopping the continuous glycerol feed, 198 grams PO were continuously fed within 21 minutes. After stopping the continuous PO feed, which was at 215 minutes after the continuous PO feed was started, the PO was allowed to react down for 30 minutes followed by stripping for 30 minutes. The amount of Polyol A used, on the basis of the total weight of final product in the reactor, was 20 wt. %. Accordingly, the build ratio (ratio of the total weight of final product to the weight of Polyol A) was 5.

Upon comparing the Reference Example and Example 1, both yielding a similar polyether polyol product, also in terms of hydroxyl number and viscosity (as shown in Table 1), it follows that surprisingly and advantageously, in a batch polyether polyol production process wherein both alkylene oxide and starting compound are continuously added, no time consuming, separate initial DMC catalyst activation step is needed, in specific no such separate DMC catalyst activation step is needed before continuous feed of the starting compound is started.

### Example 2

Example 2 was carried out in the same way as Example 1, except that the amount of fresh DMC catalyst charged to the reactor was reduced from 0.288 gram to 0.230 gram.

As can be seen from Table 1 below, surprisingly and advantageously, it appears that in a batch polyether polyol production process wherein both alkylene oxide and starting compound are continuously added and wherein there is no separate initial DMC catalyst activation step, the amount of DMC catalyst to be used may be relatively low. In Example 2 wherein a reduced DMC catalyst amount was used, a polyether polyol could still be obtained indicating that the catalyst was activated to a relatively great extent.

In addition, the polyether polyol product of Example 2 had a hydroxyl number and viscosity which were surprisingly and advantageously similar to those of the polyether polyol product of Example 1 which was made in the same way except that the DMC catalyst amount was higher.

### Example 3

Example 3 was carried out in the same way as Example 1, except that the amount of water in the glycerol was increased from 1, 600 ppmw to 2, 200 ppmw.

As can be seen from Table 1 below, surprisingly and advantageously, it appears that in a batch polyether polyol production process wherein both alkylene oxide and starting compound are continuously added and wherein there is no separate initial DMC catalyst activation step, the tolerance to water in the starter feed is relatively high. In Example 3 wherein glycerol with increased water content was used, a polyether polyol could still be obtained indicating that the catalyst was not deactivated by such high water level.

In addition, the polyether polyol product of Example 3 had a hydroxyl number and viscosity which were surprisingly and advantageously similar to those of the polyether polyol product of Example 1 which was made in the same way except that the glycerol used in Example 1 contained less water.

TABLE 1

| | | | | OH | |
|---|---|---|---|---|---|
| | | | Water in | value | Viscosity |
| | | Catalyst | glycerol | (mg | at 40 °C |
| Ex. | Description | (ppmw) | (ppmw) | KOH/g) | (mPa · s) |
| Ref. | Separate DMC | 120 | 1,600 | 253 | 103 |
| | catalyst | | | | |
| | activation step | | | | |
| 1 | No separate DMC | 120 | 1,600 | 251 | 102 |
| | catalyst | | | | |
| | activation | | | | |
| | step; glycerol | | | | |
| | feed started 2 | | | | |
| | minutes after | | | | |
| | PO feed started | | | | |
| 2 | As Example 1, | 100 | 1,600 | 249 | 100 |
| | but with | | | | |
| | reduced | | | | |
| | catalyst amount | | | | |
| 3 | As Example 1, | 120 | 2,200 | 252 | 102 |
| | but with | | | | |
| | increased water | | | | |
| | amount in | | | | |
| | glycerol | | | | |

1. A batch process for preparing a polyether polyol P having a hydroxyl number of greater than 115 mg KOH/g by reacting starter compound S₁ and optionally starter compound S₂, which starter compounds have a plurality of active hydrogen atoms, with one or more alkylene oxides in the presence of a composite metal cyanide complex catalyst, comprising
a) forming a starter mixture comprising starter compound S₁ and the catalyst, followed by
b) continuously adding an alkylene oxide; and
c) optionally: continuously adding starter compound S₂;
wherein
starter compound S₁ has (I) a nominal functionality which equals the nominal functionality of polyether polyol P and a hydroxyl number which is within 10% of the hydroxyl number of polyether polyol P and/or (II) an equivalent weight of from 10 to 500 g/mol;
optional starter compound S₂ has an equivalent weight of from 10 to 70 g/mol; and
no alkylene oxide is added in step a) or between steps a) and b), and the continuous addition of alkylene oxide in step b) is not interrupted before the total weight of alkylene oxide needed to prepare polyether polyol P has been added.

2. The process according to claim 1, wherein in step a) starter compound S₁ is combined with fresh composite metal cyanide complex catalyst.

3. The process according to claim 1, wherein starter compound S₂ is added in step c).

4. The process according to claim 3, wherein step b) starts before step c).

5. The process according to claim 3, wherein step c) is stopped before step b) is stopped.

6. The process according to claim 1, wherein the alkylene oxide added in step b) comprises one or more of propylene oxide, ethylene oxide and butylene oxide.

7. A polyether polyol obtainable by the process according to claim 1.

8. A process for preparing a polyurethane foam comprising reacting a polyether polyol and a polyisocyanate in the presence of a blowing agent, wherein the polyether polyol is a polyether polyol obtained by the process according to claim 1.

9. A polyurethane foam obtainable by the process according to claim 8.

10. A shaped article comprising a polyurethane foam obtained by the process according to claim 8.
